(19) United States
(12) Patent Application Publication
(10) Pub. No.: US 2023/0225560 A1
(43) Pub. Date: Jul. 20, 2023

(54) ARTICLE AND METHOD FOR TRANSPORTING USED AND FRESH COOKING OIL

(71) Applicant: Frontline International Inc., Cuyahoga Falls, OH (US)

(72) Inventors: John Palazzo, Akron, OH (US); Giovanni Brienza, Copley, OH (US); Zack Palazzo, Broadview Heights, OH (US)

(73) Assignee: Frontline International Inc., Cuyahoga Falls, OH (US)

(21) Appl. No.: 18/156,836

(22) Filed: Jan. 19, 2023

Related U.S. Application Data
(60) Provisional application No. 63/301,335, filed on Jan. 20, 2022.

(51) Int. Cl. A47J 37/12; B67D 7/02; B60P 3/22

(52) U.S. Cl. CPC A47J 37/1271; A47J 37/1285; B67D 7/0288; B60P 3/228; B67D 2210/00157

(57) ABSTRACT

An article has two tanks, one for storing fresh cooking oil and one for receiving used cooking oil. A new method enables a regular delivery vehicle to deliver fresh oil, and remove used oil, along with other restaurant supplies, eliminating the need for special delivery vehicles to bring and remove cooking oil.

### CROSS-REFERENCE TO RELATED APPLICATIONS

This non-provisional application claims priority to U.S. Provisional Patent Application Ser. No. 63/301,335, filed on Jan. 20, 2022.

### I. BACKGROUND

### A. Technical Field

This invention generally relates to methods and apparatuses for facilitating the transport and exchange of used cooking oil and fresh cooking oil, such as might occur in a restaurant environment.

### B. Description of Related Art

It is known to use cooking oil to fry or otherwise cook food and other products. This cooking process often occurs at homes and restaurants. High quality cooking oil is an important aspect of the quality and taste of the food cooked thereby. Therefore, numerous articles and methods of operation have grown up around the processing of such cooking oil. It is known, for example, to change out cooking oil at different intervals and various types of equipment and processes have been developed to facilitate the replacement of used cooking oil with fresh cooking oil. For example, it is known for delivery vehicles such as trucks to carry cooking oil at a restaurant or other location and have fresh cooking oil taken from the truck to containers inside the restaurant. It is also known for such a truck to arrive at a restaurant and have used cooking oil removed from the containers within the restaurant and then delivered or pumped into the truck for disposal or processing at a different location.

What is desired is a method and apparatus to better facilitate the delivery of fresh oil along with the disposal of the used cooking oil.

### II. SUMMARY

According to some embodiments of this invention, an article has two tanks, one for storing fresh cooking oil and one for receiving used cooking oil. A new method enables a regular delivery vehicle to deliver fresh oil, and remove used oil, along with other restaurant supplies, eliminating the need for special delivery vehicles to bring and remove cooking oil.

According to an exemplary embodiment, an article for transporting cooking oil includes a first tank for selectively receiving fresh cooking oil. An inflowing pipe of the first tank is provided for receiving the fresh cooking oil from a first associated source. An outflowing pipe of the first tank is provided for discharging the fresh cooking oil to an associated container. A pumping mechanism of the first tank is provided for pumping the fresh oil from the first associated source through the inflowing pipe and for pumping the fresh oil to the associated container through the outflowing pipe. A second tank is provided for selectively receiving used cooking oil. An inflowing pipe of the second tank is provided for receiving the used cooking oil from the associated container. An outflowing pipe of the second tank is provided for discharging the used cooking oil to a second associated source. A pumping mechanism of the second tank is provided for pumping the used oil from the associated container through the inflowing pipe and for pumping the used oil to the second associated source through the outflowing pipe.

According to an exemplary embodiment, the first tank is located above said second tank. The first tank and said second tank have essentially the same configuration. The first tank includes a first tank footprint and the second tank includes a second tank footprint, such that the first tank footprint is coincident with said second tank footprint.

According to an exemplary embodiment, a housing is generally upright and columnar, and the first and second tanks are configured within the housing, with the first tank being above the second tank. One or more corner guides can be provided such that one or more of the corner guides are for supporting and holding said first tank above said second tank.

According to an exemplary embodiment, the article can include a fresh oil conduit and a used oil conduit in a conduit network to respectively transport fresh oil and used oil between the first and second tanks and the associated container. The outflowing pipe of the first tank is connected to the fresh oil conduit for transporting fresh oil from the first tank to the associated container, and the inflowing pipe of the second tank is connected to the used oil conduit for transporting used oil from the associated container to the second tank. A connection of the conduit network is provided for enabling the fresh oil conduit to connect to the first associated source, and for enabling the used oil conduit to connect to the second associated source. The associated container can be one or more fryers for frying a food item in cooking oil, and one or both of the first and second associated sources is a transport vehicle for cooking oil.

According to an exemplary embodiment, an article for transporting cooking oil and storing cooking oil is provided. The article includes a first tank having a first width and first depth and extending upward with a first height to create a first volume, for selectively receiving and holding cooking oil. A second tank has a second width and second depth and extends upward with a second height to create a second volume, for selectively receiving and holding cooking oil. The first and second tanks have essentially the same configuration. A housing is generally upright and columnar, and the first and second tanks are configured within the housing, with the first tank being above the second tank.

According to an exemplary embodiment, a method is provided for delivering fresh cooking oil to a restaurant and taking away used oil from the restaurant. The method includes steps of providing an article having a first tank for receiving fresh oil and a second tank for receiving used oil. The first and second tanks have sensors capable of reporting oil levels within the tanks. A delivery vehicle having a first container containing fresh oil, a second container is provided for receiving used oil, and a third container is provided for containing associated non-oil supplies for the restaurant. A step is provided for sensing an oil level in said first tank. A step is provided for sending a signal from said sensor, calling for additional fresh oil. A step is provided for receiving said signal at an associated source of fresh oil. A step is provided for sending said delivery vehicle to the restaurant. A step is provided for delivering fresh oil from said first container to said first tank. A step is provided for transporting used oil from said second tank to said second container. The delivery vehicle can have a third container containing other restaurant supplies that are not cooking oil.

Other benefits and advantages of this invention will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows a perspective view of an article or container according to the invention.

FIG. 2 shows a perspective view of the article or container in FIG. 1, but rotated 90 degrees counterclockwise

FIG. 3 shows a cut-away, perspective view of the article or container of FIG. 2, specifically showing the first tank.

FIG. 4 shows a cut-away, perspective view of the article or container of FIG. 2, specifically showing the second tank.

FIG. 5 shows a schematic, perspective view of the article or container of in place, shown in operative relation to two associated receptacles in a restaurant.

FIG. 6 shows a schematic view of an associated restaurant fryer with pipes for inputting and removing oil and a communication link to the controller.

FIG. 7 shows another, schematic view of an associated restaurant fryer with pipes for inputting and removing oil and a communication link to the controller.

FIG. 8 shows a schematic view of the article with pipes for inputting and removing oil and a communication link to the controller.

FIG. 9 shows a schematic view of the article with pipes for inputting and removing oil and a communication link to the controller.

FIG. 10 shows a schematic view of the coupling in a wall of the associated restaurant that allows the pipes from the containers within delivery vehicle to operatively connect to the pipes that first and second tanks.

FIG. 11 shows a front view of the article.

FIG. 12 shows a side view of the article.

FIG. 13 shows a perspective view of the article.

FIG. 14 shows a top view of the article.

FIG. 15 shows a schematic illustration of a prior art cooking oil delivery system.

FIG. 16 shows a schematic illustration of a prior art cooking oil delivery system.

### IV. DETAILED DESCRIPTION

Referring now to the drawings wherein the showings are for purposes of illustrating embodiments of the invention only and not for purposes of limiting the same, and wherein like reference numerals are understood to refer to like components, the FIGURES show a container 10 with a first tank 14 and a second tank 16. The first tank 14 and the second tank 16 are configured in a columnar orientation and supported within a housing 96 by corner guides 40A, 40B, 40C and 40D.

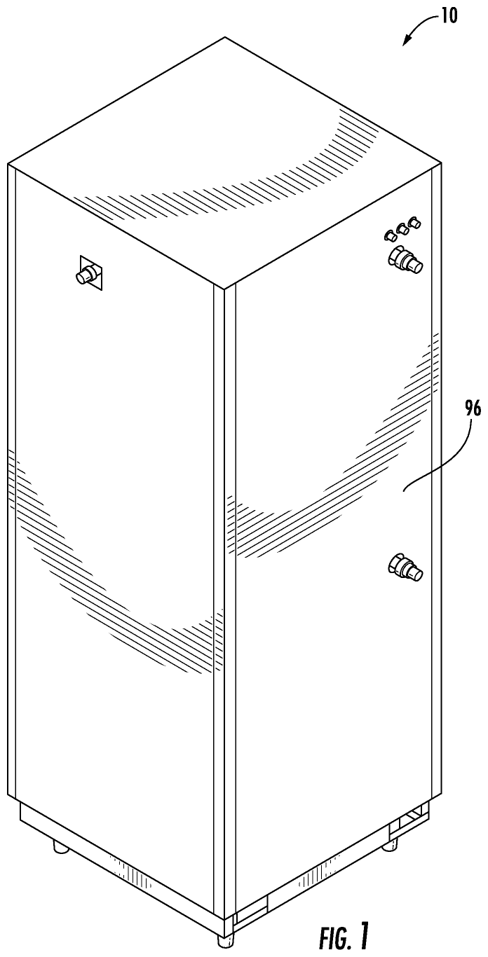

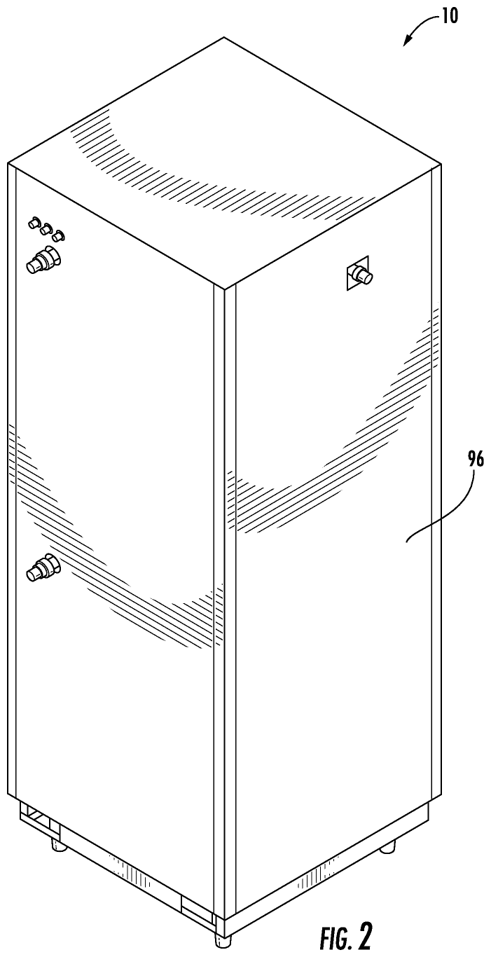

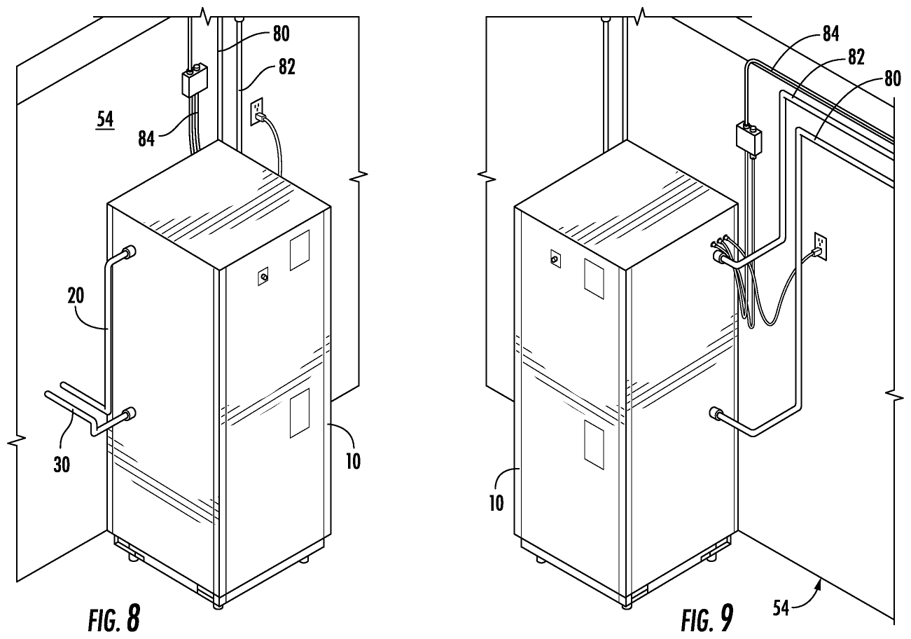

With continuing reference to FIGS. 1-16, with reference to FIG. 1, a perspective view of an article 10 or container 10 according to the invention is shown. With further reference to FIG. 2, the article 10 is shown rotated clockwise ninety degrees to the view shown in FIG. 1.

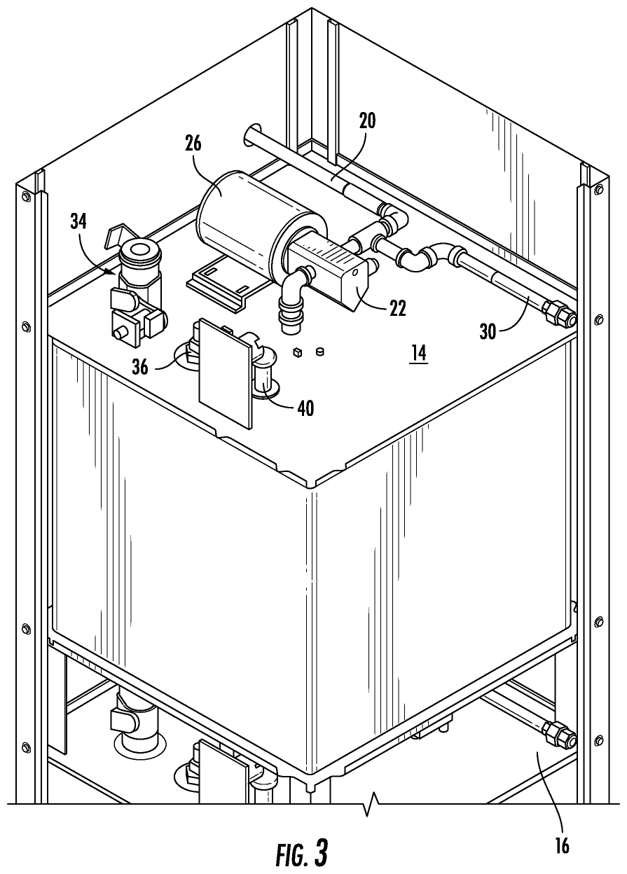

With reference to FIG. 3, the article 10 is shown in a perspective, cutaway view. With continuing reference to FIG. 3, the article 10 includes a first tank 14. In the preferred embodiment, fresh oil is contained in the first tank 14 and used cooking oil is stored in the second tank 16. However, although the invention is described herein in this manner, and illustrated in this manner in the FIGURES, the order may be reversed, where used cooking oil can be stored in the first tank 14 and fresh cooking oil in the second tank 16, or the tanks 14, 16 can be oriented differently, for example, side by side rather than in a column.

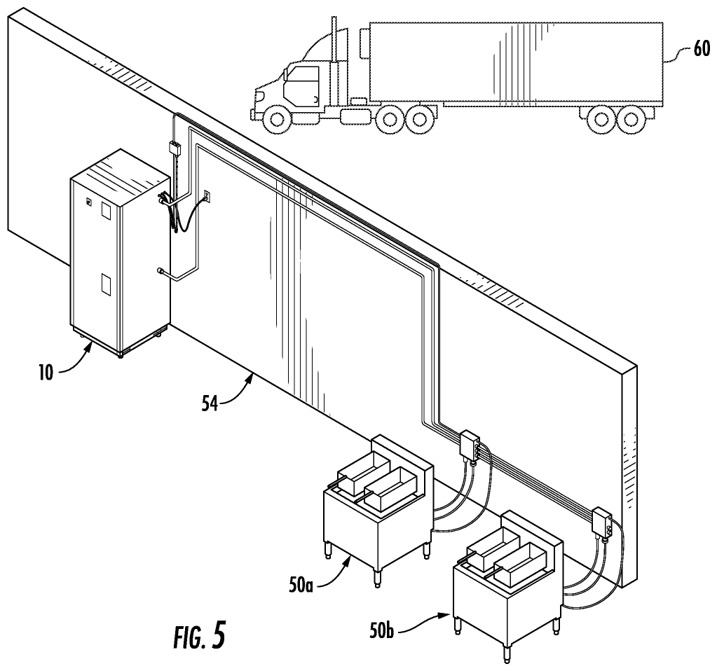

With continuing reference to FIGS. 3 and 5, an inflowing pipe 20 of the first tank 14 is illustrated which receives fresh cooking oil from an associated source, such as a delivery vehicle 60. A pumping mechanism 22 creates the suction to pull fresh oil from the associated source through the inflowing pipe 20. The pumping mechanism 22 is driven by an electric motor 26. An outflowing pipe 30 of the first tank 14 can be operatively connected to an associated container, such as a fryer 50A, 50B, within the restaurant to receive the fresh cooking oil pumped from the first tank 14. A sensor 34 can monitor how much fresh oil enters the first tank 14 through inflowing pipe 20 and how much fresh oil exits the first tank 14 through outflowing pipe 30.

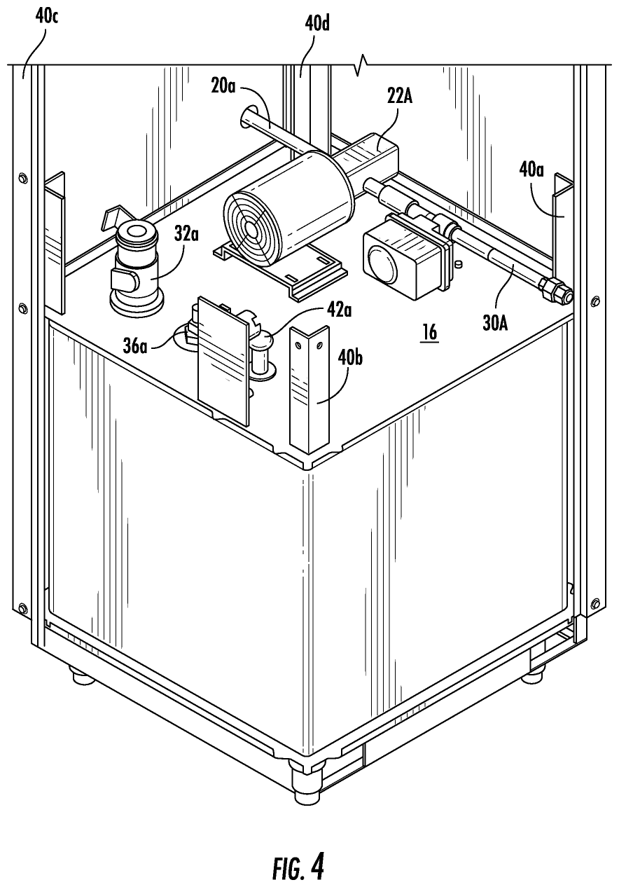

With reference to FIG. 4, the second tank 16 is illustrated. In this view of the second tank, many of the features correspond to those of the first tank 14. For example, there is an inflowing pipe 30A of the second tank 16 which can receive incoming used oil and an outflowing pipe 20A of the second tank 16 which can transfer used oil out of the second tank 16. Similarly, a pumping mechanism 22, 22A driven by electric motor 26A facilitates the transport of the used oil in the inflowing pipe 30A and the outflowing pipe 20A. A sensor 32A monitors the process.

With continuing reference to FIGS. 3 and 4, corner guides 40A, 40B, 40C, and 40D support and hold the first tank 14 above the second tank 16. In the second tank 16, the pipe 30A is the conduit out of the second tank 16 and into the associated container intended to receive the used oil, while the pipe 20A is the conduit for oil from the associated restaurant container into the second tank 16. Sensors, 32, 32A are operatively connected with the electric motors 26, 26A and the pumping mechanisms 22, 22A to avoid overfilling the tanks 14, 16. The sensors 32, 32A monitor the oil levels in the tanks 14, 16 and can contact an entity (such as via email or text message or the like) with pertinent information such as fluid level, temperature, etc. The sensors 32, 32A can therefore call for new fresh oil or call for a pickup of used oil.

With reference to FIGS. 3 and 4, second, backup sensors 36, 36A will function in case a primary sensor 32, 32A fails. Vents 42 and 42A allow air to escape as the tanks 14, 16 fill with oil. In the preferred embodiment, the article 10 is 24 inches by 24 inches and 80 inches high. Each tank 14, 16 can hold 80 gallons of oil. The first tank 14 can be understood to have a first footprint and said second tank 16 can be understood to have a second footprint, and these footprints are coincident.

With reference to FIG. 5, a schematic layout of a typical restaurant configuration is shown. The article 10 is shown mounted near an associated interior wall 54 of an associated restaurant. Containers of heated oil, such as fryers 50A and 50B are illustrated schematically. A prior art delivery vehicle 60 is schematically illustrated.

With reference to FIGS. 6, 7, 8, and 9, a schematic view of an associated restaurant fryer 50 shown with two baskets 76 such as are often used for frying French fries. The article is shown mounted against an interior wall 54 of an associated restaurant. Pipes or conduits 80, 82 for inputting and removing oil and a communication link 84 to the controller 32.

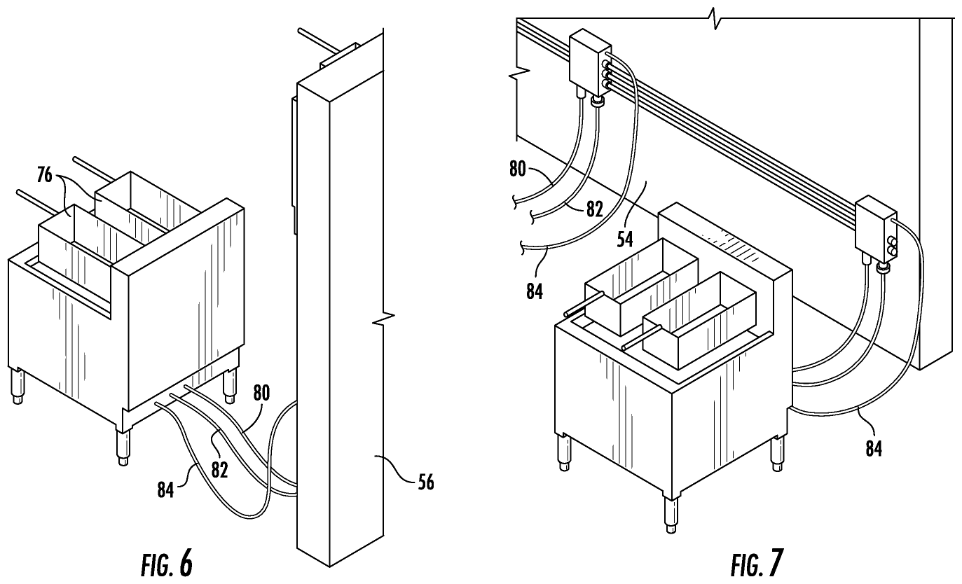

As depicted in FIGS. 6 and 7, the pipes or conduits 80, 82 are included in a conduit network and are thereby suitably connected to the pipes 30, 30A of the container 10 to transport cooking oil to and from the fryers 56A, 50B. As shown in FIGS. 3 and 8, the conduit 82 is a fresh oil conduit 82 that connects to the outflowing pipe 30 of the first tank 14 to transport outgoing fresh oil to the fryers 50A, 50B from the first tank 14 of the container 10. As shown in FIGS. 4 and 8, the conduit 80 is a used oil conduit 80 that connects to the inflowing pipe 30A of the second tank 16 to transport incoming used oil from the fryers 50A, 50B to the second tank 16 of the container 10.

With reference to FIG. 10 shows a schematic view of a connection 90 mounted in a wall 54, 56 of the associated restaurant that connects to the conduit network and thereby allows the pipes 70, 72 from the containers 66A, 66B within delivery vehicle 60 to operatively connect to the pipes 20, 20A operatively connected to the first tank 14 and the second tank 16. In a preferred embodiment, access to the connection 90 is selectively had via a door 92 which is preferably securable via a lock and key.

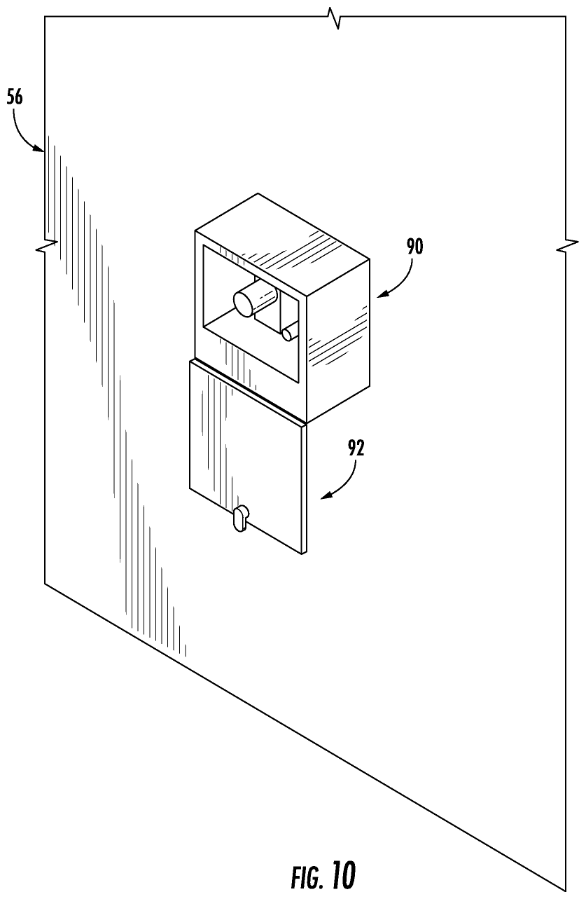

FIG. 11 shows a front view of the article 10.

FIG. 12 shows a side view of the article 10.

FIG. 13 shows a perspective view of the article 10.

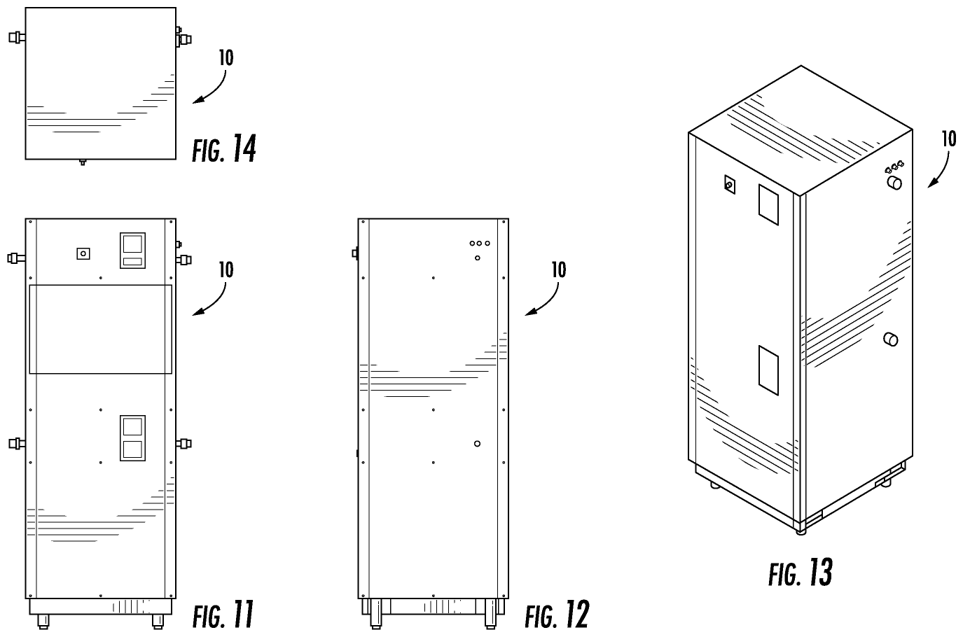

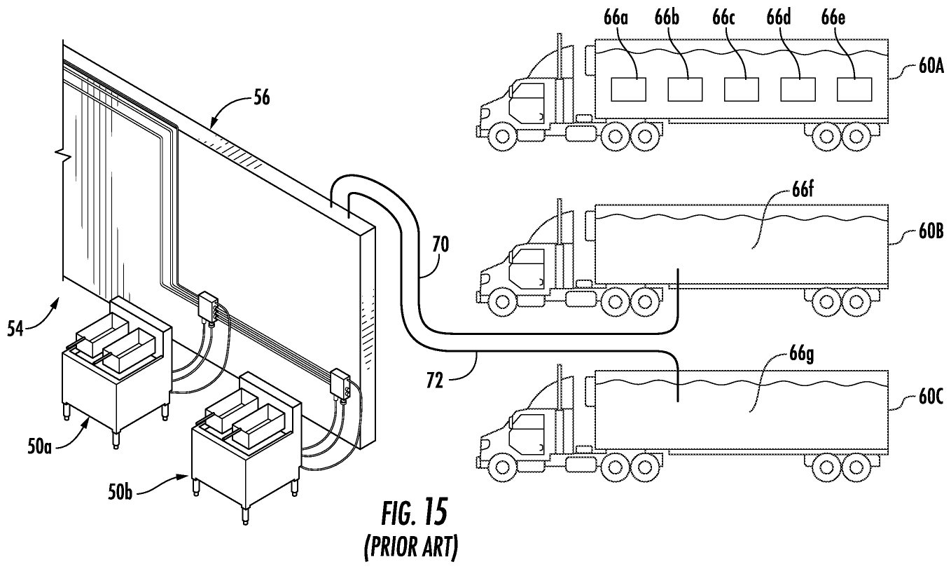

FIG. 14 shows a top view of the article 10. In one embodiment, the article 10 is approximately 24 inches by 24 inches and is 80 inches tall. The first and second tanks 14, 16 each hold 80 gallons of oil.

FIG. 15 shows a schematic illustration of a prior art cooking oil delivery system.

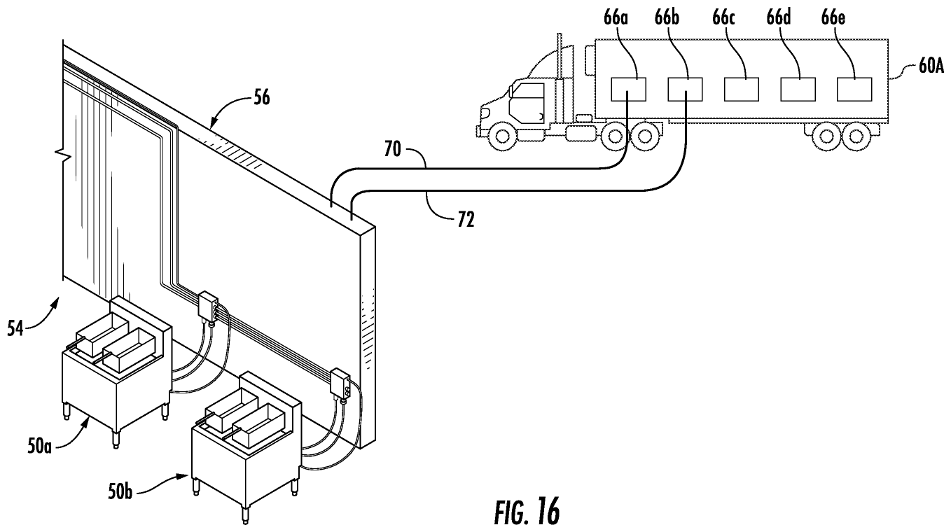

FIG. 16 shows a schematic illustration of a prior art cooking oil delivery system.

With reference to FIGS. 5 and 15, and 16, another aspect of the invention will be described. With reference to FIG. 15, a prior art method of supplying an associated restaurant or other user of cooking oil is illustrated. A first source of supply, such as a delivery vehicle 60A is shown in a schematic cutaway view, with containers 66A-66E of supplies within the delivery vehicle 60A. Containers 66A-66E might contain a variety of restaurant supplies, such as napkins, hamburger patties, hamburger buns, frozen French fries, and the like.

With continuing reference to FIG. 15, second and third delivery vehicles 60B and 60C are also illustrated. Second delivery vehicle 60B is configured to have a single container 66F to contain fresh oil. The fresh oil can be delivered to the appropriate container or fryer (not shown) in the restaurant by conduit 70. Similarly, third delivery vehicle 60C is configured to have a single container 66G to receive and take away used oil. The used oil can be removed from the appropriate container or fryer (not shown) in the restaurant by conduit 72 and then stored in the container 66G within the third delivery vehicle 60C. Note that typical, prior art oil delivery system requires one delivery vehicle 60B to bring fresh oil to the restaurant, and then a second delivery vehicle 60C, to remove the used oil and take it away from the restaurant. These two delivery vehicles are in addition to the other delivery vehicle 60A or vehicles that bring other supplies.

With reference to FIG. 16, the inventive article and method will be described. A first source of supply, such as a delivery vehicle 60A is shown in a schematic cutaway view, with containers 66A-66E of supplies within the delivery vehicle 60A. Containers 66A-66E might contain a variety of restaurant supplies, such as napkins, hamburger patties, hamburger buns, frozen french fries, and the like. However, in the inventive method, container 66A contains fresh oil and container 66B can receive used oil. The fresh oil can be delivered from container 66A to the appropriate container or fryer (not shown) in the restaurant by conduit 70. The used oil can be removed from the appropriate container or fryer (not shown) in the restaurant by conduit 72 and then stored in the container 66B within the first delivery vehicle 60A. In one embodiment of the invention, container 66A and container 66B located on the delivery vehicle 60A can be replaced by placing an article 10 on the delivery vehicle 60A. In this embodiment, a first article 10 on the delivery vehicle 60A will send cooking oil to a second article 10 located within the restaurant, via the conduits 70, 72 as shown in FIGS. 10 and 15.

Note that the inventive oil delivery system requires only one delivery vehicle 60A to bring fresh oil to the restaurant, to remove the used oil and take it away from the restaurant, and deliver other, non-oil related supplies to the restaurant.

The benefits of this innovative system are many. Timely deliveries are likely more possible because smaller deliveries of supplies occur nearly every day. Smaller trucks can likely be used for deliveries. Fewer accidents in the restaurant's parking lot are likely to occur. A single truck and driver are more likely able to service the restaurant, rather than two or three trucks and drivers. An oil supplier or restaurant do not need to own their own oil tankers or large trucks configured for oil transport. Rather, regular commercial delivery trucks and vehicles can carry the containers necessary to bring fresh oil or receive used oil.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. Further, the “invention” as that term is used in this document is what is claimed in the claims of this document. The right to claim elements and/or sub-combinations that are disclosed herein as other inventions in other patent documents is hereby unconditionally reserved.

Having thus described the invention, it is now claimed:

What is claimed:

1. An article for transporting cooking oil, the article comprising:
a first tank, said first tank selectively receiving fresh cooking oil;
an inflowing pipe of the first tank for receiving the fresh cooking oil from a first associated source;
an outflowing pipe of the first tank for discharging the fresh cooking oil to an associated container;
a pumping mechanism of the first tank for pumping the fresh oil from the first associated source through the inflowing pipe and for pumping the fresh oil to the associated container through the outflowing pipe;
a second tank, said second tank selectively receiving used cooking oil;
an inflowing pipe of the second tank for receiving the used cooking oil from the associated container;
an outflowing pipe of the second tank for discharging the used cooking oil to a second associated source; and
a pumping mechanism of the second tank for pumping the used oil from the associated container through the inflowing pipe and for pumping the used oil to the second associated source through the outflowing pipe.

2. The article of claim 1 wherein said first tank is located above said second tank.

3. The article of claim 1 wherein said first tank and said second tank have essentially the same configuration.

4. The article of claim 1 wherein said first tank further comprises a first tank footprint and said second tank further comprises a second tank footprint, said first tank footprint being coincident with said second tank footprint.

5. The article of claim 1 further comprising a housing, said housing being generally upright and columnar, said first and second tanks being configured within the housing, with the first tank being above the second tank.

6. The article of claim 5 further comprising at least one corner guide, said at least one corner guide supporting and holding said first tank above said second tank.

7. The article of claim 1 further comprising a fresh oil conduit and a used oil conduit in a conduit network to respectively transport fresh oil and used oil between the first and second tanks and the associated container.

8. The article of claim 7 wherein the outflowing pipe of the first tank is connected to the fresh oil conduit for transporting fresh oil from the first tank to the associated container, and wherein the inflowing pipe of the second tank is connected to the used oil conduit for transporting used oil from the associated container to the second tank.

9. The article of claim 7 further comprising a connection of the conduit network for enabling the fresh oil conduit to connect to the first associated source, and for enabling the used oil conduit to connect to the second associated source.

10. The article of claim 1 wherein the associated container is at least one fryer for frying a food item in cooking oil, and wherein at least one of the first and second associated sources is a transport vehicle for cooking oil.

11. An article for transporting cooking oil and storing cooking oil, said article comprising:
a first tank, said first tank having a first width and first depth and extending upward with a first height to create a first volume, said first tank selectively receiving and holding cooking oil;
a second tank, said second tank having a second width and second depth and extending upward with a second height to create a second volume, said second tank selectively receiving and holding cooking oil, said first and second tanks having essentially the same configuration; and,
a housing, said housing being generally upright and columnar, said first and second tanks being configured within the housing, with the first tank being above the second tank.

12. A method of delivering fresh cooking oil to a restaurant, and taking away used oil from the restaurant, the method comprises steps of:
providing an article having a first tank for receiving fresh oil and a second tank for receiving used oil, said first and second tanks having sensors capable of reporting oil levels within the tanks;
providing a delivery vehicle having a first container containing fresh oil, a second container for receiving used oil, and a third container containing associated non-oil supplies for the restaurant;
sensing an oil level in said first tank;
sending a signal from said sensor, calling for additional fresh oil;
receiving said signal at an associated source of fresh oil;
sending said delivery vehicle to the restaurant;
delivering fresh oil from said first container to said first tank; and,
transporting used oil from said second tank to said second container.

13. The method of claim 12 wherein said delivery vehicle has a third container containing other restaurant supplies that are not cooking oil.
